(19) United States
(12) Patent Application Publication
(10) Pub. No.: US 2007/0281099 A1
(43) Pub. Date: Dec. 6, 2007

(54) Solderable pads utilizing nickel and silver nanoparticle ink jet inks

(75) Inventors: James J. Howarth, Albuquerque, NM (US); Anthony R. James, Rio Rancho, NM (US); Karel Vanheusden, Placitas, NM (US)

Correspondence Address: Jaimes Sher, Esq.;Cabot Corporation, 5401 Venice Avenue NE, Albuquerque, NM, 87113, US

(73) Assignee: Cabot Corporation, Boston, MA (US)

(21) Appl. No.: 11/443,265

(22) Filed: May 31, 2006

(51) Int. Cl. B05D 1/12; B05D 3/02; B05D 7/00; B05C 5/00; B41J 2/01

(52) U.S. Cl. 427/402; 427/372.2; 427/180; 347/102; 118/300; 118/58

(57) ABSTRACT

A system and a method are provided for ink-jet printing a solderable conductive pad onto a substrate. The system comprises at least one print head and a curing station for curing an ink deposited onto the substrate. The system is configured to: deposit at least a first layer of a first ink onto the substrate; cure the first layer of the first ink; deposit at least an intermediate layer of a second ink on top of the cured first layer of the first ink; cure the intermediate layer of the second ink; deposit at least a last layer of the first ink on top of the cured intermediate layer of the second ink; and cure the last layer of the first ink. The first ink has a relatively high conductivity. The second ink has a relatively low conductivity. The first layer, the intermediate layer, and the last layer may be arranged such that when solder is applied to the last layer, the solder is prevented from leaching through to the first layer.

### BACKGROUND OF THE INVENTION

1. Field of the Invention

The present invention relates to ink-jet printing of electrical components onto a substrate using conductive inks. More particularly, the invention relates to a method and apparatus for printing solderable pads onto a substrate using layers of inks that are selected to prevent leaching of solder through to the base ink layer.

2. Related Art

In the conventional manufacture of printed circuit boards (PCBs), a laminate comprising a dielectric substrate having a copper sheet affixed to at least one side is prepared. The copper surface is overlaid with a photo-resist layer which is typically a carboxylic acid containing polyacrylate. A phototool is prepared which is a negative image of the desired copper electrically conductive circuitry, and this is typically a silver halide photographic emulsion. The phototool is placed over the photo-resist layer and irradiated with actinic radiation, such as ultraviolet (UV) light. This causes the photo-resist layer which is exposed to the actinic radiation to polymerize and harden, thus producing a latent negative image of the desired circuitry in the photo-resist layer. The unexposed areas of the photo-resist layer which have not been exposed to actinic radiation are then removed using mildly aqueous alkali to expose the copper surface, and this is then removed by chemical etching, thus resulting in a dielectric substrate containing the required copper circuitry covered by polymerized photo-resist. This photo-resist is finally removed to yield a dielectric substrate having the required copper electrically conductive circuitry.

PCBs are now complex sandwiches of numerous individual dielectric substrates containing copper electrically conductive circuitry on one or both sides. The circuitry of these individual elements must be electrically joined in a precise manner in forming the final PCB. This is typically achieved by using a similar process to that used in preparing the copper electrically conductive circuitry by the photo-resist process described above. Thus, the individual elements comprising a dielectric substrate containing the copper electrically conductive circuitry are coated with a solder mask liquid film which is based on acrylates having carboxylic acid groups. This solder mask film is applied in such a manner to cover the copper circuitry and also penetrate between different tracks of the copper circuitry down to the surface of the dielectric substrate itself. A phototool is prepared which is a negative image of those parts of the copper circuitry which it is desired to join. This phototool is typically a silver halide emulsion which is similar to that used in the photo etch-resistant preparation of the electrically conductive copper circuitry. The phototool is placed over the solder mask liquid film and irradiated with actinic radiation, such as UV light. This causes the acrylate liquid solder mask to polymerize and harden where it is exposed to actinic radiation. The unexposed areas of the solder mask are then removed using dilute aqueous alkali, thereby exposing those parts of the electrically conductive copper circuitry which it is desired to electrically join. The retained solder mask is generally further polymerized and hardened by exposure to high temperatures, typically in the 120-160 degrees Celsius range. The exposed copper surface is then coated with a liquid solder paste which is held in place by the cured parts of the solder mask and heated to melt the solder paste.

When the PCB is a sandwich containing two or more dielectric substrates with copper electrically conductive circuitry, the separate dielectric substrates are connected together by a dielectric prepreg which is compatible with the substrate.

The solder mask also provides protection against heat, environmental damage, and breakdown of the PCB during its life. Consequently, it is common to apply the solder mask also to the outer surface(s) of the PCB.

There are a number of deficiencies inherent in this process using solder masks. It is a multi-stage process involving six discrete stages, and it requires the separate preparation of a phototool. The liquid solder mask film is applied over the whole surface of the dielectric substrate containing the required electrically conductive circuitry, including those areas from which it is subsequently removed. This is wasteful of materials. The phototool is distanced from the solder mask film, and because of light diffraction, some areas of the liquid solder mask which are not directly beneath the exposed areas of the phototool may tend to polymerize, and therefore become more difficult to remove using aqueous alkali. This adversely affects the definition and line density of those parts of the copper circuitry for which it is desired to expose for contact with the solder paste. Furthermore, use of solder mask acrylate polymers which need to be quickly and effectively removed in a relatively short time frame requires a relatively high carboxylic acid content. This can have an adverse impact on those parts of the solder mask which are retained for protection of the individual elements of the PCB. A high number of residual carboxylic acid groups can also reduce the electrical sensitivity of the retained parts of the solder mask by conversion to the salt of the carboxylic acid.

There is therefore a clear advantage in eliminating the need for a phototool and developing a process wherein the solder mask is applied directly to selected areas of a dielectric substrate by ink jet printing wherein the image is computer generated. This reduces the number of processing stages, since it is then only necessary to apply the solder mask to the required parts of the dielectric substrate containing the copper circuitry, and to polymerize the solder mask. Such a process saves on solder mask materials, since it is only applied to those areas it is required to cover. It also eliminates flow problems in applying liquid solder mask to the whole of the dielectric substrate containing the copper circuitry where it is often difficult to avoid entrainment of air between adjacent copper tracks, which can adversely affect PCB performance and longevity. Since such a process does not involve a phototool which is distanced from the surface of the solder mask, there is no actinic radiation diffraction and polymerization of the solder mask which is not directly below the transparent areas of the phototool. This offers the potential for greater definition and line density of the solder paste. Because the solder mask is only applied to the required areas of the dielectric substrate containing the copper circuitry, it is not necessary to selectively remove the solder mask from undesired areas by aqueous alkali treatment. The solder mask does not, therefore, need to have a high carboxylic acid content which offers the potential for improved electrical resistance of the solder mask.

A shortcoming of conventional systems involves a potential for leaching of the solder through the solder mask to the underlying solder pad. Such leaching can cause significantly reduced performance of the electrically circuitry. Accordingly, there is a need for an ink-jet process for printing solderable pads that include solder masks that effectively prevent leaching of the solder material through the mask to the pad and to the substrate.

### SUMMARY OF THE INVENTION

In one aspect, the invention provides an ink-jet printing system for printing a solderable conductive pad onto a substrate. The system comprises at least one print head and a curing station for curing an ink deposited onto the substrate. The system is configured to: deposit at least a first layer of a first ink onto the substrate; cure the first layer of the first ink; deposit at least an intermediate layer of a second ink on top of the cured first layer of the first ink; cure the intermediate layer of the second ink; deposit at least a last layer of the first ink on top of the cured intermediate layer of the second ink; and cure the last layer of the first ink. The first ink has a relatively high conductivity. The second ink has a relatively low conductivity. The first layer, the intermediate layer, and the last layer may be arranged such that when solder is applied to the last layer, the solder is prevented from leaching through to the first layer.

The first ink may comprise silver nanoparticles. The second ink may comprise nickel nanoparticles. The first ink may comprise copper nanoparticles. A thickness of any or all of the cured first layer of the first ink, the cured intermediate layer of the second ink, and the cured last layer of the first ink may be within a range between approximately 1 μm and approximately 20 μm, or more preferably within a range between approximately 2 μm and approximately 8 μm.

The system may be further configured to: deposit and cure at least one intermediate layer of the first ink prior to depositing the last layer of the first ink; and deposit and cure at least a second intermediate layer of the second ink prior to depositing the last layer of the first ink. The curing station may be configured to cure an ink deposited on the substrate by using at least one of the group consisting of a heating block, convective heating, infrared radiation, ultraviolet radiation, and microwave radiation.

In another aspect, the invention provides a process for ink-jet printing a solderable conductive pad onto a substrate. The process comprises the steps of: depositing a first layer of a first ink onto the substrate; curing the deposited first layer; depositing an intermediate layer of a second ink on top of the cured first layer; curing the deposited intermediate layer; depositing a last layer of the first ink on top of the cured intermediate layer; and curing the deposited last layer. The first ink has a relatively high conductivity. The second ink has a relatively low conductivity. The first layer, the intermediate layer, and the last layer may be arranged such that when solder is applied to the last layer, the solder is prevented from leaching through to the first layer.

The first ink may comprise silver nanoparticles. The second ink may comprise nickel nanoparticles. The first ink may comprise copper nanoparticles. A thickness of any or all of the cured first layer of the first ink, the cured intermediate layer of the second ink, and the cured last layer of the first ink may be within a range between approximately 1 μm and approximately 20 μm, or more preferably within a range between approximately 2 μm and approximately 8 μm.

The process may further include the steps of: depositing at least one intermediate layer of the first ink prior to depositing the last layer of the first ink; curing the deposited at least one intermediate layer of the first ink; depositing at least a second intermediate layer of the second ink prior to depositing the last layer of the first ink; and curing the deposited at least second intermediate layer of the second ink. Each of the curing steps may be carried out by using one of the group consisting of a heating block, convective heating, infrared radiation, ultraviolet radiation, and microwave radiation.

### BRIEF DESCRIPTION OF THE DRAWINGS

FIG. 1 illustrates an ink-jet printing apparatus having a single fixed printer head and a curing station according to a preferred embodiment of the invention.

FIG. 2 illustrates an ink-jet printing apparatus having a moving print head assembly and a curing station according to a preferred embodiment of the invention.

FIG. 3 illustrates an exemplary solderable conductive pad having a first and last layer of silver ink with an intermediate barrier layer of nickel ink on a Kapton substrate, according to a preferred embodiment of the invention.

FIGS. 4A, 4B, and 4C illustrate exemplary printed patterns after respective deposits of a first, second, and third layer of ink according to a preferred embodiment of the invention.

FIG. 5 shows a flow chart that illustrates a process of ink-jet printing a solderable conductive pad onto a substrate according to a preferred embodiment of the invention.

### DETAILED DESCRIPTION OF THE INVENTION

In one aspect, the invention provides an ink-jet printing system for printing a solderable conductive pad onto a substrate. The system comprises at least one print head and a curing station for curing an ink deposited onto the substrate. The system is configured to: deposit at least a first layer of a first ink onto the substrate; cure the first layer of the first ink; deposit at least an intermediate layer of a second ink on top of the cured first layer of the first ink; cure the intermediate layer of the second ink; deposit at least a last layer of the first ink on top of the cured intermediate layer of the second ink; and cure the last layer of the first ink. The first ink has a relatively high conductivity. The second ink has a relatively low conductivity. The first layer, the intermediate layer, and the last layer may be arranged such that when solder is applied to the last layer, the solder is prevented from leaching through to the first layer.

The first ink may comprise silver nanoparticles. The second ink may comprise nickel nanoparticles. The first ink may comprise copper nanoparticles. A thickness of any or all of the cured first layer of the first ink, the cured intermediate layer of the second ink, and the cured last layer of the first ink may be within a range between approximately 1 μm and approximately 20 μm, or more preferably within a range between approximately 2 μm and approximately 8 μm. The solder may include a lead-tin solder. Alternatively, the solder may include a lead-based solder in which lead is combined with another metal other than tin.

The system may be further configured to: deposit and cure at least one intermediate layer of the first ink prior to depositing the last layer of the first ink; and deposit and cure at least a second intermediate layer of the second ink prior to depositing the last layer of the first ink. The curing station may be configured to cure an ink deposited on the substrate by using at least one of the group consisting of a heating block, convective heating, infrared radiation, ultraviolet radiation, and microwave radiation.

In another aspect, the invention provides a process for ink-jet printing a solderable conductive pad onto a substrate. The process comprises the steps of: depositing a first layer of a first ink onto the substrate; curing the deposited first layer; depositing an intermediate layer of a second ink on top of the cured first layer; curing the deposited intermediate layer; depositing a last layer of the first ink on top of the cured intermediate layer; and curing the deposited last layer. The first ink has a relatively high conductivity. The second ink has a relatively low conductivity. The first layer, the intermediate layer, and the last layer may be arranged such that when solder is applied to the last layer, the solder is prevented from leaching through to the first layer.

The first ink may comprise silver nanoparticles. The second ink may comprise nickel nanoparticles. The first ink may comprise copper nanoparticles. A thickness of any or all of the cured first layer of the first ink, the cured intermediate layer of the second ink, and the cured last layer of the first ink may be within a range between approximately 1 μm and approximately 20 μm, or more preferably within a range between approximately 2 μm and approximately 8 μm. The solder may include a lead-tin solder. Alternatively, the solder may include a lead-based solder in which lead is combined with another metal other than tin.

The process may further include the steps of: depositing at least one intermediate layer of the first ink prior to depositing the last layer of the first ink; curing the deposited at least one intermediate layer of the first ink; depositing at least a second intermediate layer of the second ink prior to depositing the last layer of the first ink; and curing the deposited at least second intermediate layer of the second ink. Each of the curing steps may be carried out by using one of the group consisting of a heating block, convective heating, infrared radiation, ultraviolet radiation, and microwave radiation.

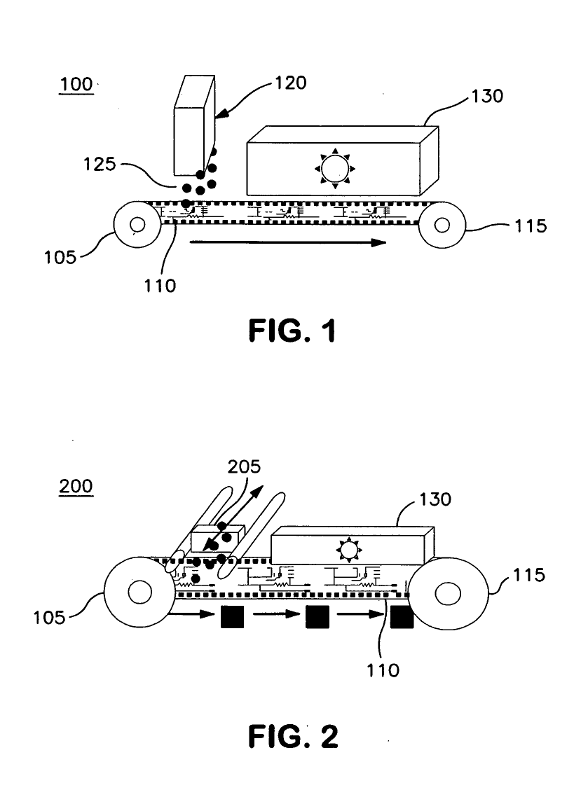

The present inventor has recognized that there is an industry need for a relatively efficient and inexpensive apparatus and methodology for printing solderable conductive pads using an ink-jet printing process and inks that are selected and arranged so that the solder does not leach through the pad to the conductive layer at the substrate. Referring to FIG. 1, an exemplary apparatus 100 according to a preferred embodiment of the invention includes a supply roll 105 for feeding a flexible substrate 110 to a second roll 115, which is used for takeup of the substrate 110. A fixed print head 120 is positioned relatively near to the feed roll 105. The fixed print head 120 is loaded with an electronic ink 125. Similar as with a standard ink-jet printer, the fixed print head 120 is configured to deposit the ink 125 onto the substrate 110 in a predetermined pattern. In a preferred embodiment, the print width of the fixed print head is approximately in the range of 500 mm to 600 mm.

The feed and takeup rolls 105 and 115 may be configured to continuously feed the substrate 110 across the fixed print head 120. The apparatus 100 also includes a curing station 130, which is configured to cure the deposited ink 125. The curing station may use any of several known mechanisms for curing. Examples of curing mechanisms include: the use of a heating block; convective heating; infrared radiation; ultraviolet radiation; and microwave radiation.

Referring to FIG. 2, a second exemplary roll-to-roll ink-jet printing apparatus 200 according to another preferred embodiment of the invention includes a moving print head assembly 205, which is loaded with the electronic ink 125. The apparatus 200 also includes a feed roll 105, a takeup roll 115, and a curing station 130.

Typically, apparatus 200 is configured to feed a portion of the substrate 110 into a position at which the ink 125 may be deposited, and then to stop the feed while the moving print head assembly 205 deposits the ink 125 onto that portion of the substrate. After the ink has been deposited, then the substrate is shifted so that the curing station 130 is positioned for drying the just-deposited ink 125, and the moving print head assembly 205 is then positioned to deposit more ink 125 onto a new portion of the substrate 110. The process of 1) shifting a portion of the substrate through the use of the feed and takeup rolls 105,115; 2) depositing ink 125 using the moving print head assembly 205; and 3) curing the just-deposited ink using the curing station 130 is repeated until the entire substrate 110 has been fed from the feed roll 105 to the takeup roll 115, or until all of the ink 125 required by the predetermined pattern has been deposited and cured.

In a preferred embodiment, the substrate 110 may be composed of polyimide, for example, a Kapton roll. In another preferred embodiment, the substrate 110 may be selected from the group consisting of PEN, PET, various thin metal and plastic films, membrane materials, coated paper, and uncoated paper. In addition, the substrate 110 may also be composed of a rigid material, such as those used in conventional printed circuit boards.

The apparatus 100 or 200 of the present invention may be used for depositing a plurality of electronic inks. This may be accomplished either by loading in separate electronic inks into the single print head 120 or 205, or through the use of multiple print heads, either fixed or movable.

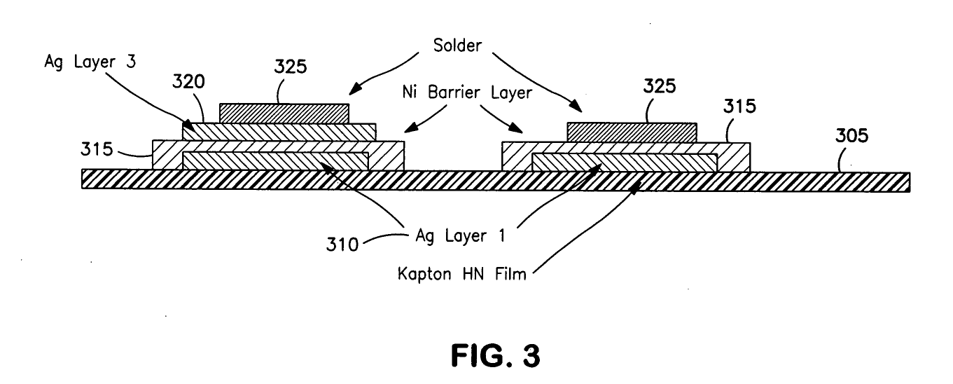

Referring to FIG. 3, a exemplary solderable conductive pad according to a preferred embodiment of the present invention is shown on the left side. On the right side of FIG. 3, an example of a solderable conductive pad according to an alternative embodiment of the invention is shown. Both solderable conductive pads are placed on top of a Kapton film substrate 305. The first layer 310 of electronic ink uses a silver ink, which is relatively highly conductive. The silver ink may typically be an ink-jet printable ink that includes silver nanoparticles. A barrier layer 315 of nickel ink is situated on top of and completely enclosing the first layer 310 of silver ink. The purpose of the barrier layer 315, also referred to as an intermediate layer 35, is to insulate the silver ink by using a nickel ink which, while still conductive, has a relatively lower conductivity. The nickel ink may typically be an ink-jet printable ink that includes nickel nanoparticles. In the less preferred example on the right side, a solder pad 325 is applied directly onto the barrier layer 315 of nickel ink. The problem with this is that the solder may tend to leach through the nickel ink, thereby creating an undesirable direct electrical connection between the solder and the first layer 310 of silver ink.

In the preferred example shown on the left side of FIG. 3, an additional last layer 320 of silver ink is deposited on top of the intermediate layer 315 of nickel ink. Then, the solder pad 325 is applied on top of this last layer 320 of silver ink. By including the last layer 320 of silver ink, the solder is effectively prevented from leaching through the intermediate layer 315 of nickel ink, while preserving the desired conductivity and the desired barrier protection for the first layer 310 of silver ink.

In experiments conducted by the inventors of the present invention, the use of the last layer 320 of silver ink effectively prevented the solder from leaching through the intermediate layer 315 of nickel ink. However, it is believed that such leaching may be minimized or prevented for the alternative embodiment as shown on the right side of FIG. 3, depending on certain factors such as the porosity of the nickel ink, the thickness of the intermediate layer 315 of nickel ink, and the rate of temperature increase during the curing of the intermediate layer 315. Accordingly, both exemplary embodiments shown in FIG. 3 may be used to achieve the objective of preventing the leaching of the solder down to the first layer 310 of silver ink.

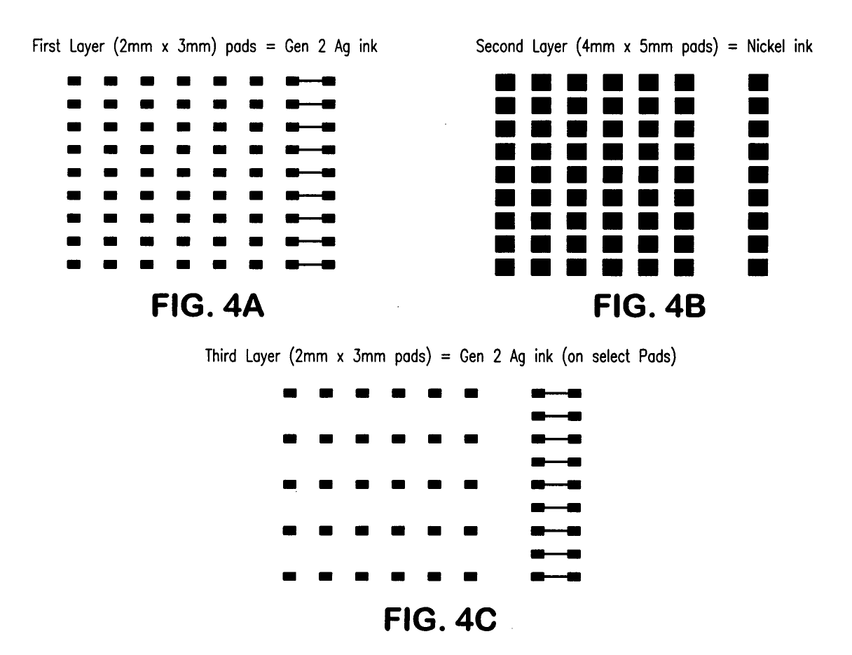

Referring to FIGS. 4A, 4B, and 4C, an exemplary series of stages of production of solderable conductive pads according to a preferred embodiment of the invention are illustrated. In FIG. 4A, a first layer of silver ink is deposited in squares measuring approximately 2 mm×3 mm directly to a substrate in an arrayed pattern. In FIG. 4B, an intermediate layer of nickel ink is deposited on top of the respective squares of silver ink. In order to assure that the squares in the first layer are completely covered by the nickel ink, the respective deposits of nickel ink measure approximately 4 mm×5 mm. Notably, in order to ensure that the respective inks do not blend or mix, the first layer of silver ink is typically dried, or cured, prior to the deposit of the intermediate layer of nickel ink. Then, in FIG. 4C, a third layer of silver ink is deposited on top of the intermediate layer for each respective square. In this instance, it is not important to completely cover the nickel ink. So, to be economical of space and ink, the third layer is deposited in squares that measure approximately 2 mm×3 mm. Once again, the intermediate layer of nickel ink is typically dried, or cured, prior to the deposit of the third layer of silver ink. The measurements of the pads and the measurements of the respective layers of ink may be chosen liberally, depending on the operational needs for the particular application; therefore, these measurements are shown by way of example only and are not intended to be limiting in any sense.

Notably, for some applications, additional layers of silver and nickel ink may be used. For example, a first layer of silver ink, then a first barrier layer of nickel ink, a second layer of silver ink, a second barrier layer of nickel ink, and then a last layer of silver ink may be deposited to form a solderable conductive pad. It is contemplated by the present inventors that any number of additional pairs of layers of silver and nickel ink may be used to construct the solderable conductive pad, depending on the particular requirements of the specific application.

While the use of silver ink as a highly conductive ink for the first and last layers is preferred, it is also contemplated that other relatively highly conductive materials may be used. For example, a copper ink, i.e., an electronic ink that includes copper nanoparticles, may be used instead of silver ink. In addition, while the use of nickel ink as a relatively low conductivity ink for the intermediate or barrier layer is preferred, it is also contemplated that other suitable materials may be used. For example, a tin ink or a gold ink, i.e., an electronic ink that includes either tin nanoparticles or gold nanoparticles, may be used instead of nickel ink.

Experimentation conducted by the present inventors yielded optimum results when using a lead-tin solder. However, it is contemplated that any other solder type may be used. For example, a solder that includes a combination of lead and a metal other than tin may be used.

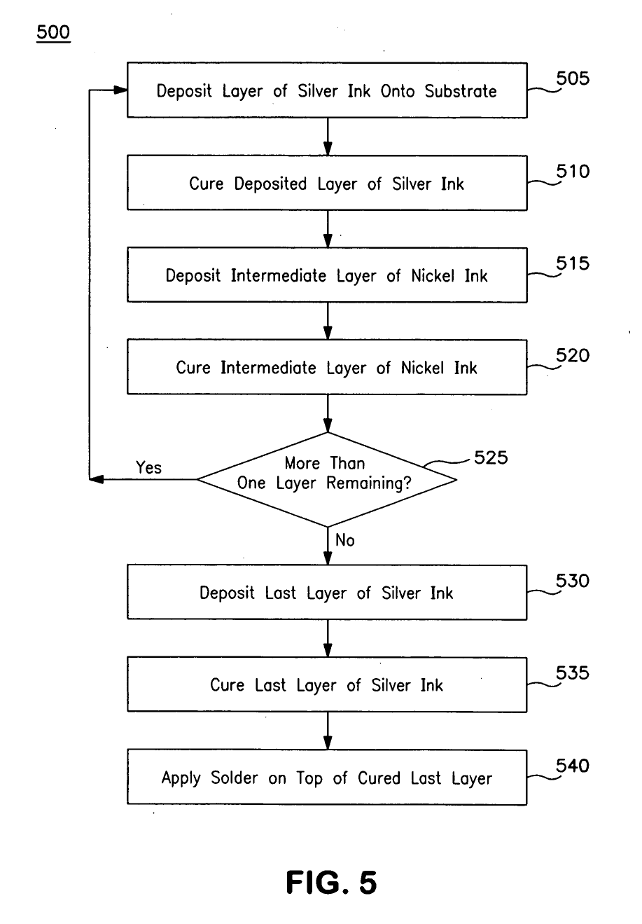

Referring to FIG. 5, a flowchart 500 is provided which illustrates a process for ink-jet printing a solderable conductive pad onto a substrate according to a preferred embodiment of the invention. The first step 505 is to deposit a first layer of silver ink onto the substrate. Then, the first layer of silver ink is cured (or dried) at step 510. At step 515, an intermediate layer of nickel ink is deposited on top of the cured first layer of silver ink, and then this intermediate layer of nickel ink is cured at step 520. At step 525, it is determined whether additional pairs of layers of silver and nickel ink will be included for this specific solderable conductive pad. If it is determined at 525 that additional layers will be used, then the process returns to step 505, and steps 505, 510, 515, and 520 are repeated. These four steps may be repeated any number of cycles until it is determined at step 525 that there is only one last layer of silver ink remaining for the given solderable conductive pad.

Once it is determined at step 525 that only one additional layer of ink will be used, the last layer of silver ink is deposited at step 530 and then cured at step 535. Finally, the solder itself is applied to the solderable pad at step 540, thus enabling a circuit element or connector to be attached to the printed circuit board via the newly constructed solderable conductive pad.

While the present invention has been described with respect to what is presently considered to be the preferred embodiment, it is to be understood that the invention is not limited to the disclosed embodiments. To the contrary, the invention is intended to cover various modifications and equivalent arrangements included within the spirit and scope of the appended claims. The scope of the following claims is to be accorded the broadest interpretation so as to encompass all such modifications and equivalent structures and functions.

What is claimed is:

1. An ink-jet printing system for printing a solderable conductive pad onto a substrate, the system comprising at least one print head and a curing station for curing an ink deposited onto the substrate, wherein the system is configured to:
deposit at least a first layer of a first ink onto the substrate, the first ink having a relatively high conductivity;
cure the first layer of the first ink;
deposit at least an intermediate layer of a second ink on top of the cured first layer of the first ink, the second ink having a relatively low conductivity;
cure the intermediate layer of the second ink;
deposit at least a last layer of the first ink on top of the cured intermediate layer of the second ink; and
cure the last layer of the first ink.

2. The ink-jet printing system of claim 1, wherein the first layer, the intermediate layer, and the last layer are arranged such that when solder is applied to the last layer, the solder is prevented from leaching through to the first layer.

3. The ink-jet printing system of claim 1, wherein the first ink comprises silver nanoparticles.

4. The ink-jet printing system of claim 1, wherein the second ink comprises nickel nanoparticles.

5. The ink-jet printing system of claim 1, wherein the first ink comprises silver nanoparticles and the second ink comprises nickel nanoparticles.

6. The ink-jet printing system of claim 1, wherein the first ink comprises copper nanoparticles and the second ink comprises nickel nanoparticles.

7. The ink-jet printing system of claim 1, wherein a thickness of the cured first layer of the first ink is within a range between approximately 1 μm and approximately 20 μm.

8. The ink-jet printing system of claim 7, wherein a thickness of the cured first layer of the first ink is within a range between approximately 2 μm and approximately 8 μm.

9. The ink-jet printing system of claim 1, wherein a thickness of the cured intermediate layer of the second ink is within a range between approximately 1 μm and approximately 20 μm.

10. The ink-jet printing system of claim 9, wherein a thickness of the cured intermediate layer of the second ink is within a range between approximately 2 μm and approximately 8 μm.

11. The ink-jet printing system of claim 1, wherein a thickness of the cured last layer of the first ink is within a range between approximately 1 μm and approximately 20 μm.

12. The ink-jet printing system of claim 11, wherein a thickness of the cured last layer of the first ink is within a range between approximately 2 μm and approximately 8 μm.

13. The ink-jet printing system of claim 1, wherein the system is further configured to:
deposit and cure at least one intermediate layer of the first ink prior to depositing the last layer of the first ink; and
deposit and cure at least a second intermediate layer of the second ink prior to depositing the last layer of the first ink.

14. The ink-jet printing system of claim 1, wherein the curing station is configured to cure an ink deposited on the substrate by using at least one of the group consisting of a heating block, convective heating, infrared radiation, ultraviolet radiation, and microwave radiation.

15. A process for ink-jet printing a solderable conductive pad onto a substrate, the process comprising the steps of:
depositing a first layer of a first ink onto the substrate, the first ink having a relatively high conductivity;
curing the deposited first layer;
depositing an intermediate layer of a second ink on top of the cured first layer, the second ink having a relatively low conductivity;
curing the deposited intermediate layer;
depositing a last layer of the first ink on top of the cured intermediate layer; and
curing the deposited last layer.

16. The process of claim 15, wherein the first layer, the intermediate layer, and the last layer are arranged such that when solder is applied to the last layer, the solder is prevented from leaching through to the first layer.

17. The process of claim 15, wherein the first ink comprises silver nanoparticles.

18. The process of claim 15, wherein the second ink comprises nickel nanoparticles.

19. The process of claim 15, wherein the first ink comprises silver nanoparticles and the second ink comprises nickel nanoparticles.

20. The process of claim 15, wherein the first ink comprises copper nanoparticles and the second ink comprises nickel nanoparticles.

21. The process of claim 15, wherein a thickness of the cured first layer of the first ink is within a range between approximately 1 μm and approximately 20 μm.

22. The process of claim 21, wherein a thickness of the cured first layer of the first ink is within a range between approximately 2 μm and approximately 8 μm.

23. The process of claim 15, wherein a thickness of the cured intermediate layer of the second ink is within a range between approximately 1 μm and approximately 20 μm.

24. The process of claim 23, wherein a thickness of the cured intermediate layer of the second ink is within a range between approximately 2 μm and approximately 8 μm.

25. The process of claim 15, wherein a thickness of the cured last layer of the first ink is within a range between approximately 1 μm and approximately 20 μm.

26. The process of claim 25, wherein a thickness of the cured last layer of the first ink is within a range between approximately 2 μm and approximately 8 μm.

27. The process of claim 15, further comprising the steps of:
depositing at least one intermediate layer of the first ink prior to depositing the last layer of the first ink;
curing the deposited at least one intermediate layer of the first ink;
depositing at least a second intermediate layer of the second ink prior to depositing the last layer of the first ink; and
curing the deposited at least second intermediate layer of the second ink.

28. The process of claim 15, wherein each of the curing steps is carried out by using one of the group consisting of a heating block, convective heating, infrared radiation, ultraviolet radiation, and microwave radiation.
